(19) United States
(12) Patent Application Publication
(10) Pub. No.: US 2022/0317613 A1
(43) Pub. Date: Oct. 6, 2022

(54) CONSUMABLE CHIP, CONSUMABLE AND COMMUNICATION METHOD

(71) Applicant: Zhuhai Pantum Electronics Co., Ltd., Zhuhai (CN)

(72) Inventors: Chengzhu YU, Zhuhai (CN); Dan NING, Zhuhai (CN)

(21) Appl. No.: 17/704,704

(22) Filed: Mar. 25, 2022

(30) Foreign Application Priority Data
Apr. 1, 2021 (CN) 202110358080.8

(51) Int. Cl. G03G 15/00

(52) U.S. Cl. CPC G03G 15/5087; G03G 15/5091; G03G 15/553

(57) ABSTRACT

The present disclosure provides a consumable chip, a consumable, and a communication method between the image forming apparatus and the consumable chip. The consumable chip is capable of being installed on the consumable, and the consumable is capable of being detachably installed on the image forming apparatus. The consumable chip includes a first storage unit and a chip control unit. The first storage unit is configured to store first fixed data representing attribute information of the consumable. The chip control unit is configured to receive an authentication request sent by the image forming apparatus, obtain the first fixed data and first variable data representing consumption information of the consumable, generate authentication data by performing a calculation on the first fixed data and the first variable data according to a first preset algorithm, and send the authentication data for determining whether the consumable meets expectation to the image forming apparatus.

### CROSS-REFERENCE TO RELATED APPLICATION

This application claims the priority of Chinese patent application No. 202110358080.8, filed on Apr. 1, 2021, the entirety of which is incorporated herein by reference.

### FIELD OF THE DISCLOSURE

The present disclosure generally relates to the field of image forming technology and, more particularly, relates to a consumable chip, a consumable, and a communication method between the image forming apparatus and the consumable chip.

### BACKGROUND

To ensure data security during the communication process between a consumable and an image forming apparatus, a fixed password is often used to encrypt the communication data between the image forming apparatus and the consumable. However, in the process of encrypting the communication data by using the fixed password and sending the communication data to the image forming apparatus, due to the poor stability and reliability of the fixed password, the image forming apparatus is likely to authenticate the consumable that does not meet the quality requirements. The use of the consumable that does not meet the quality requirements for imaging may cause damage to the image forming apparatus and may affect the imaging quality.

### BRIEF SUMMARY OF THE DISCLOSURE

One aspect of the present disclosure provides a consumable chip. The consumable chip is capable of being installed on a consumable, and the consumable is capable of being detachably installed on an image forming apparatus. The consumable chip includes a first storage unit and a chip control unit. The first storage unit is configured to store first fixed data representing attribute information of the consumable. The chip control unit is configured to receive an authentication request sent by the image forming apparatus, obtain the first fixed data and first variable data representing consumption information of the consumable based on the authentication request, generate authentication data by performing a calculation on the first fixed data and the first variable data according to a first preset algorithm, and send the authentication data to the image forming apparatus. The authentication data is used to determine whether the consumable meets expectation.

Another aspect of the present disclosure provides a consumable. The consumable includes a case, a developer accommodating unit disposed in the case and configured to accommodate developer, and a consumable chip. The consumable chip is capable of being installed on a consumable, and the consumable is capable of being detachably installed on an image forming apparatus. The consumable chip includes a first storage unit and a chip control unit. The first storage unit is configured to store first fixed data representing attribute information of the consumable. The chip control unit is configured to receive an authentication request sent by the image forming apparatus, obtain the first fixed data and first variable data representing consumption information of the consumable based on the authentication request, generate authentication data by performing a calculation on the first fixed data and the first variable data according to a first preset algorithm, and send the authentication data to the image forming apparatus. The authentication data is used to determine whether the consumable meets expectation.

Another aspect of the present disclosure provides a consumable. The consumable includes an organic photoconductor, a charging roller configured to charge the organic photoconductor, and a consumable chip. The consumable chip is capable of being installed on a consumable, and the consumable is capable of being detachably installed on an image forming apparatus. The consumable chip includes a first storage unit and a chip control unit. The first storage unit is configured to store first fixed data representing attribute information of the consumable. The chip control unit is configured to receive an authentication request sent by the image forming apparatus, obtain the first fixed data and first variable data representing consumption information of the consumable based on the authentication request, generate authentication data by performing a calculation on the first fixed data and the first variable data according to a first preset algorithm, and send the authentication data to the image forming apparatus. The authentication data is used to determine whether the consumable meets expectation.

Another aspect of the present disclosure provides an image forming apparatus. The image forming apparatus is installed with a consumable, and the consumable is installed with a consumable chip. The image forming apparatus includes an image forming control unit. The image forming control unit is configured to send an authentication request to the consumable chip, and receive authentication data sent by the consumable chip based on the authentication request. The authentication data is obtained by performing a calculation on first fixed data representing attribute information of the consumable and first variable data representing consumption information of the consumable according to a first preset algorithm. The image forming control unit is also configured to obtain second fixed data representing the attribute information of the consumable and second variable data representing the consumption information of the consumable, and generate reference data by performing a calculation on the second fixed data and the second variable data according to the first preset algorithm. Further, the image forming control unit is configured to determine whether the authentication data is consistent with the reference data, to determine whether the consumable meets expectation.

Another aspect of the present disclosure provides a communication method between an image forming apparatus and a consumable chip. The communication method is applied to the image forming apparatus and the consumable chip. The image forming apparatus is detachably installed with a consumable, and the consumable is installed with the consumable chip. The image forming apparatus includes an image forming control unit, and the consumable chip includes a chip control unit. The communication method includes sending, by the image forming control unit, an authentication request to the consumable chip. The communication method also includes obtaining, by the chip control unit, first fixed data representing attribute information of the consumable and first variable data representing consumption information of the consumable based on the authentication request, and generating, by the chip control unit, authentication data by performing a calculation on the first fixed data and the first variable data according to a first preset algorithm. In addition, the communication method includes sending, by the chip control unit, the authentication data to the image forming control unit. Moreover, the communication method includes obtaining, by the image forming control unit, second fixed data representing the attribute information of the consumable and second variable data representing the consumption information of the consumable, and generating, by the image forming control unit, reference data by performing a calculation on the second fixed data and the second variable data according to the first preset algorithm. Further, the communication method includes determining, by the image forming control unit, whether the authentication data is consistent with the reference data, to determine whether the consumable meets expectation.

Other aspects of the present disclosure can be understood by those skilled in the art in light of the description, the claims, and the drawings of the present disclosure.

### BRIEF DESCRIPTION OF THE DRAWINGS

To more clearly illustrate the technical solutions in the disclosed embodiments of the present disclosure, drawings to be used in the description of the disclosed embodiments will be briefly described below. It is obvious that the drawings in the following description are certain embodiments of the present disclosure, and other drawings may be obtained by a person of ordinary skill in the art in view of the drawings provided without creative efforts.

FIG. 1 illustrates a schematic diagram of an exemplary image forming apparatus consistent with an embodiment of the present disclosure;

FIG. 2 illustrates a schematic diagram of an exemplary image forming apparatus and a consumable chip consistent with an embodiment of the present disclosure;

FIG. 3 illustrates a schematic flowchart of an exemplary communication method between an image forming apparatus and a consumable chip consistent with an embodiment of the present disclosure;

FIG. 4 illustrates a schematic flowchart of another exemplary communication method between an image forming apparatus and a consumable chip consistent with an embodiment of the present disclosure;

FIG. 5 illustrates a schematic sub-flowchart of an exemplary communication method between an image forming apparatus and a consumable chip consistent with an embodiment of the present disclosure; and

FIG. 6 illustrates a schematic sub-flowchart of another exemplary communication method between an image forming apparatus and a consumable chip consistent with an embodiment of the present disclosure.

### DETAILED DESCRIPTION

To more clearly illustrate aims, technical solutions, and advantages of the disclosed embodiments of the present disclosure, the technical solutions in the disclosed embodiments of the present disclosure will be clearly and fully described with reference to the accompanying drawings in the disclosed embodiments of the present disclosure. Obviously, the described embodiments are some but not all of the embodiments of the present disclosure. Based on the disclosed embodiments of the present disclosure, persons of ordinary skill in the art may derive other embodiments without creative efforts, all of which are within the scope of the present disclosure.

The present disclosure provides an image forming apparatus, a consumable chip and a communication method between the image forming apparatus and the consumable chip. Each of a body side of the image forming apparatus and a chip side may include an electrical contact portion. When the consumable is installed on the image forming apparatus, the electrical contact portion on the body side of the image forming apparatus may be in contact with the electrical contact portion of the chip side. The electrical contact portion may include a conductive plane, a conductive probe, a conductive coil, etc. The image forming apparatus may be configured to perform an image forming job, such as generating, printing, receiving and transmitting image data. The image forming apparatus may include an ink jet printer, a laser printer, a light-emitting diode (LED) printer, a copier, a facsimile machine, a scanner, an all-in-one multifunctional machine, and a multi-functional peripheral (MFP) that performs the above functions in a single device. The image forming apparatus may include an image forming control unit and an image forming unit. The image forming control unit may be configured to control the entire image forming apparatus, and the image forming unit may be configured to form an image on the supplied paper under the control of the image forming control unit based on the image data.

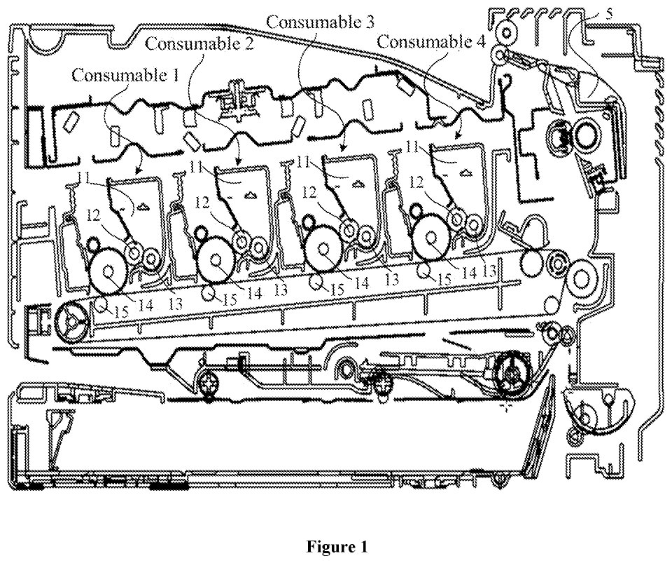

FIG. 1 illustrates a schematic diagram of an image forming apparatus consistent with an embodiment of the present disclosure. Referring to FIG. 1, as an example of the image forming apparatus, the image forming unit of the image forming apparatus may include: a developer accommodating unit 11, a developing unit 12, a developer conveying unit 13, a photosensitive unit 14, a transfer unit 15 and a fixing assembly 5, etc. The to-be-printed paper may move towards a paper feeding direction, may successively undergo a toner feeding operation of the developer conveying unit 13 and a developing operation of the developing unit 12, may reach a nip region between the photosensitive unit 14 and the transfer unit 15 for transferring, and then may undergo a fixing operation of the fixing assembly 5 to complete the image forming operation. The developer accommodating unit 11 may be configured to accommodate developer, and the developer may include colorful toner, toner and any other material. The developing unit 12 may include a developing roller and any other component. The developer conveying unit 13 may include a powder feeding roller and any other component. The photosensitive unit 14 may include an organic photo-conductor drum, a charging roller and any other component, and the charging roller may be configured to charge the organic photo-conductor drum.

The image forming apparatus may often include at least one consumable that is capable of being detachably installed on the image forming apparatus. The image forming apparatus shown in FIG. 1 may be used as an example, four consumables (consumable 1, consumable 2, consumable 3, and consumable 4, respectively as shown in FIG. 1) may be detachably installed on the image forming apparatus. The four consumables may be configured to provide developer of four colors of black K, cyan C, magenta M, and yellow Y, respectively, for the image forming apparatus. In another embodiment, a quantity of consumables installed on the image forming apparatus may increase or decrease, for example, the quantity may include one or six, which may not be limited by the present disclosure.

In one embodiment, the consumable may have a split structure, and may include a developing cartridge and a drum cartridge. The developing cartridge and the drum cartridge may be disassembled respectively. The developing cartridge may include a developing cartridge chip, and the drum cartridge may include a drum cartridge chip. The developing cartridge chip and the drum cartridge chip may be configured to store information such as toner content and a quantity of printed pages, respectively. In one embodiment, the developing cartridge may include a case, the developer accommodating unit 11, the developing unit 12 and the developer conveying unit 13. The developer accommodating unit 11 may be located in the case for accommodating the developer, and the developer conveying unit 13 may be configured to convey the developer. The drum cartridge may include the photosensitive unit 14, etc.

In another embodiment, the consumable may have an all-in-one structure. For example, the consumable (consumable 1, consumable 2, consumable 3 or consumable 4) may include the developer accommodating unit 11, the developing unit 12, the developer conveying unit 13, the photosensitive unit 14, and the transfer unit 15, etc. In other words, in the present disclosure, the consumable with the all-in-one structure may often include one consumable chip. The consumable with the split structure may often include two consumable chips, which may be installed in the developing cartridge and the drum cartridge, respectively.

It should be noted that the consumable in the disclosed embodiments may be the above-mentioned developing cartridge or the above-mentioned drum cartridge, or may include both the developing cartridge and the drum cartridge, which may not be limited herein. The consumable in the disclosed embodiments may include any other component, part, and unit in the image forming apparatus that tends to be damaged and needs to be replaced, such as a paper box, a toner cartridge, etc. Correspondingly, the above-mentioned consumable chip may be installed on the above-mentioned consumable, and the consumable chip may be configured to record the state of the consumable to facilitate the image forming apparatus to centrally manage the consumables installed thereon. The consumable chip may store related information of the consumable, such as product model, color/type and production date of a recording material (such as ink, toner), usage information of printing media (such as toner, paper, etc.), a quantity of printed pages, serial number, etc. At the same time, the consumable chip may be authenticated by the image forming apparatus, to prevent the image forming apparatus from using consumable that cannot meet the predetermined quality requirements to perform imaging.

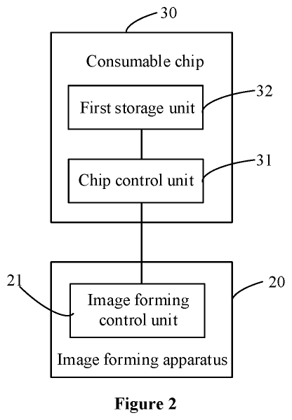

FIG. 2 illustrates a schematic diagram of an image forming apparatus and a consumable chip consistent with an embodiment of the present disclosure. Referring to FIG. 2, an image forming apparatus 20 may include an image forming control unit 21. A consumable chip 30 may be detachably installed on a consumable, and the consumable may be detachably installed on the image forming apparatus 20. The consumable chip 30 may include a chip control unit 31 and a first storage unit 32.

The image forming control unit 21 may be configured to send an authentication request to the consumable chip 30. The authentication request may be a signal for the image forming apparatus 20 to request authentication data from the consumable chip 30.

The first storage unit 32 may be configured to store first fixed data representing attribute information of the consumable. The chip control unit 31 may be configured to receive the authentication request sent by the image forming apparatus 20, and obtain the first fixed data and first variable data representing consumption information of the consumable based on the authentication request. The chip control unit 31 may be further configured to generate authentication data by performing a calculation on the first fixed data and the first variable data based on a first preset algorithm, and send the authentication data to the image forming apparatus 20 to determine whether the consumable meets expectation.

The chip control unit 31 may be connected to the image forming control unit 21 through a data bus, and thus data transmission may be performed between the chip control unit 31 and the image forming control unit 21 through the data bus. The image forming control unit 21 may send the authentication request to the data bus, and the chip control unit 31 may receive the authentication request from the data bus.

The first fixed data may include the serial number of the consumable, the model of the consumable, the capacity of the consumable, or any other fixed attribute information of the consumable. The first fixed data may be fixedly stored in the first storage unit 32, and the first fixed data may not change with the execution of image formation.

The first variable data may include information of a quantity of printed pages, remaining amount of the consumable, consumption amount of the consumable, or any other rewritable consumption information of the consumable. The first variable data may be rewritten or changed according to the consumption status of the consumable in the image forming operation performed by the image forming apparatus 20. The consumable chip 30 may save the first variable data after the image forming apparatus 20 has performed the image forming operation.

The chip control unit 31 may generate the authentication data by performing a calculation on the first fixed data and the first variable data based on the first preset algorithm, which may specifically include: combining the first fixed data and the first variable data to generate first combined data; encrypting the first combined data to generate first to-be-processed data; performing signature calculation on the first to-be-processed data to generate first signature data; and encrypting the first to-be-processed data and the first signature data to generate the authentication data.

Combining the first fixed data and the first variable data to generate the first combined data may include following. In one embodiment, each of the first fixed data and the first variable data may be an entirety, and the two entireties may be spliced without changing the specific content of the first fixed data and the first variable data to generate the first combined data. In another embodiment, the first fixed data may be split to obtain a plurality of first split data, and the first variable data may be split to obtain a plurality of second split data. The plurality of first split data and the plurality of second split data may be arranged according to a preset arrangement rule to generate the first combined data. In certain embodiments, a part of the plurality of first split data and a part of the plurality of second split data may be extracted and randomly arranged to generate the first combined data. The first fixed data and the first variable data may be combined in any other method, which may not be limited by the present disclosure.

Encrypting the first combined data to generate the first to-be-processed data may include following. The first combined data may be encrypted using a preset encryption algorithm to generate the first to-be-processed data. The preset encryption algorithm may include any one of an AES (advanced encryption standard) algorithm, a DES (data encryption standard) algorithm, a 3DES (triple DES) algorithm, and a SM4 algorithm, or any other encryption algorithm, which may not be limited by the present disclosure.

Signature calculation may refer to an algorithm for digital signature. A digital signature may include a digital string that is generated by the sender and cannot be forged. The digital string may be an effective proof of the authenticity of the information sent by the sender. When verifying the signature, when the input data is inconsistent, the signature value may be different. The receiver may recalculate the signature of the data, and may compare the recalculated signature of the data with the original stored signature, to check whether the data has been rewritten, and to verify whether the data has been fully sent to the receiver without being tampered and deleted.

The first fixed data may undergo multiple encryption and signature calculations, and the result obtained each time may be the same, in other words, a fixed result may be obtained. When performing multiple encryption and signature calculations on the combined data of the first variable data and the first fixed data, because the first variable data is different each time, the results obtained by performing multiple encryption and signature calculations on the combined data of the first variable data and the first fixed data may be different, in other words, variable results may be obtained. The analysis of the variable results may be more difficult than the analysis of the fixed result, thereby improving the security and reliability of the authentication data. In addition, because the first fixed data and the first variable data are combined to obtain the first combined data, a data length of the first combined data may be greater than a data length of the first fixed data. The encryption difficulty of the first combined data may increase, and the decryption difficulty of the first combined data may increase, thereby further improving the security and reliability of the authentication data.

The image forming control unit 21 may receive the authentication data sent by the consumable chip 30 based on the authentication request. The authentication data may be obtained by performing a calculation on the first fixed data representing the attribute information of the consumable and the first variable data representing the consumption information of the consumable based on the first preset algorithm.

The image forming control unit 21 may be further configured to obtain second fixed data representing attribute information of the consumable and second variable data representing consumption information of the consumable, and to generate reference data by performing a calculation on the second fixed data and the second variable data based on the first preset algorithm. The image forming control unit 21 may be further configured to determine whether the authentication data and the reference data are consistent, to determine whether the consumable meets expectation.

The second fixed data may include the serial number of the consumable, the model of the consumable, the capacity of the consumable, or any other fixed attribute information of the consumable. The second fixed data may be fixedly stored in the image forming apparatus 20, and the second fixed data may not change with the execution of image formation. The serial number of the consumable may be used as the identification information of the consumable, to prevent the consumable that does not have the corresponding serial number from being installed on the image forming apparatus 20.

The image forming control unit 21 may obtain the second fixed data and the second variable data from the consumable chip 30. In another embodiment, the image forming control unit 21 may obtain the first fixed data, and may configure the first fixed data as the second fixed data; and may obtain the first variable data, and may configure the first variable data as the second variable data.

The second variable data may include information of a quantity of printed pages, remaining amount of the consumable, consumption amount of the consumable, or any other rewritable consumption information of the consumable. The second variable data may be rewritten or changed according to the consumption status of the consumable in the image forming operation performed by the image forming apparatus 20. The second variable data may be saved after the image forming apparatus 20 has performed the image forming operation.

The image forming control unit 21 may generate the reference data by performing a calculation on the second fixed data and the second variable data based on the first preset algorithm, which may include: combining the second fixed data and the second variable data to generate second combined data; encrypting the second combined data to generate second to-be-processed data; performing signature calculation on the second to-be-processed data to generate second signature data; and encrypting the second to-be-processed data and the second signature data to generate the reference data.

Combining the second fixed data and the second variable data to generate the second combined data may include following. In one embodiment, each of the second fixed data and the second variable data may be an entirety, and the two entireties may be spliced without changing the specific content of the second fixed data and the second variable data to generate the second combined data. In another embodiment, the second fixed data may be split to obtain a plurality of third split data, and the second variable data may be split to obtain a plurality of fourth split data. The plurality of third split data and the plurality of fourth split data may be arranged according to a preset arrangement rule to generate the second combined data. In certain embodiments, a part of the plurality of third split data and a part of the plurality of fourth split data may be extracted and randomly arranged to generate the second combined data. The second fixed data and the second variable data may be combined in any other method, which may not be limited by the present disclosure.

Encrypting the second combined data to generate the second to-be-processed data may include following. The second combined data may be encrypted using a preset encryption algorithm to generate the second to-be-processed data. The preset encryption algorithm may include any one of an AES (advanced encryption standard) algorithm, a DES (data encryption standard) algorithm, a 3DES (triple DES) algorithm, and a SM4 algorithm, or any other encryption algorithm, which may not be limited by the present disclosure.

The second fixed data may undergo multiple encryption and signature calculations, and the result obtained each time may be the same, in other words, a fixed result may be obtained. When performing multiple encryption and signature calculations on the combined data of the second variable data and the second fixed data, because the second variable data is different each time, the results obtained by performing multiple encryption and signature calculations on the combined data of the second variable data and the second fixed data may be different, in other words, variable results may be obtained. The analysis of the variable results may be more difficult than the analysis of the fixed result, thereby improving the security and reliability of the reference data. In addition, because the second fixed data and the second variable data are combined to obtain the second combined data, a data length of the second combined data may be greater than a data length of the second fixed data. The encryption difficulty of the second combined data may increase, and the decryption difficulty of the second combined data may increase, thereby further improving the security and reliability of the reference data.

In one embodiment, the image forming control unit 21 may be further configured to send a parameter acquisition request to the consumable chip 30. The parameter acquisition request may be a request signal for the image forming apparatus 20 to obtain preset parameters from the consumable chip 30.

The chip control unit 31 may be further configured to receive the parameter acquisition request sent by the image forming apparatus 20, and obtain preset parameters provided by the consumable chip 30 based on the parameter acquisition request. The chip control unit 31 may be further configured to generate conversion data corresponding to the preset parameters by performing a calculation on the authentication data and the preset parameters based on a second preset algorithm, and to send the conversion data to the image forming apparatus 20, such that the image forming apparatus 20 may execute a preset strategy based on the conversion data.

The image forming apparatus may receive the conversion data sent by the consumable chip 30 based on the parameter acquisition request. The conversion data may be generated by performing a calculation on the authentication data and the preset parameters provided by the consumable chip 30 based on the second preset algorithm. The image forming control unit 21 may be further configured to execute the preset strategy based on the reference data and the conversion data.

The preset parameters may include image forming control parameters and consumable parameters. The image forming control parameters may include control parameters used by the image forming apparatus 20 for performing an imaging operation. The image forming control parameters may include at least one of a high voltage compensation parameter corresponding to environmental parameter, a calibration parameter in a colorful image forming manner, a transfer voltage and a developing voltage.

The consumables chip 30 may store the preset parameters in plaintext, or may store the preset parameters in ciphertext.

When the consumable chip 30 stores the preset parameters in plaintext, after receiving the parameter acquisition request sent by the image forming apparatus 20, the chip control unit 31 may generate the conversion data corresponding to the preset parameters by performing a calculation on the authentication data and the preset parameters based on the second preset algorithm. Then, the chip control unit 31 may send the conversion data to the image forming apparatus 20. After receiving the conversion data, the image forming control unit 21 may decrypt the conversion data based on the reference data and the second preset algorithm.

When the consumable chip 30 stores the preset parameters in the form of ciphertext, the chip control unit 31 may encrypt the preset parameters using the authentication data based on the second preset algorithm, to generate the conversion data corresponding to the preset parameters. The consumable chip 30 may store the preset parameters. After receiving the parameter acquisition request sent by the image forming apparatus 20, the chip control unit 31 may send the conversion data to the image forming apparatus 20. After receiving the conversion data, the image forming control unit 21 may decrypt the conversion data based on the reference data and the second preset algorithm.

When the preset parameters include image forming control parameters, the preset strategy may include determining whether the consumable meets expectation according to the image forming control parameters. In other words, the image forming control unit 21 may determine whether the consumable meets expectation according to the image forming control parameters. When it is determined that the consumable meets expectation, the consumable may be used for imaging. The image forming control unit 21 may adjust the characteristics of the image forming control parameters, thereby improving the image forming effect.

When the preset parameters include consumable parameters, the preset strategy may include obtaining information of the consumable according to the consumable parameters. The image forming control unit 21 may obtain information related to the consumable through the consumable parameters.

In one embodiment, the chip control unit 31 may generate the conversion data by performing an encryption calculation on the preset parameters using the authentication data obtained by performing a calculation on the first fixed data and the first variable data. Then, the chip control unit 31 may send the conversion data to the image forming control unit 21. The image forming control unit 21 may decrypt the conversion data using the reference data obtained by performing a calculation on the second fixed data and the second variable data. Because the authentication data and the reference data are dynamically variable, the authentication data may be used to encrypt the preset parameters, which may improve the difficulty of data analysis. Further, the authentication data may be updated in real time, which may make it substantially difficult to crack the conversion data, thereby enhancing the security and reliability of the data sent by the chip control unit 31 to the image forming control unit 21, and may prevent the data sent by the chip control unit 31 to the image forming control unit 21 from being maliciously intercepted and embezzled.

In the disclosed image forming apparatus 20 and the consumable chip 30, the chip control unit 31 of the consumable chip 30 may generate the authentication data using the stored first fixed data and the first variable data. The image forming apparatus 20 may authenticate the consumable chip 30 using the authentication data. Because the authentication data is dynamically variable, the authentication data received by the image forming apparatus 20 may be highly reliable, and the image forming apparatus 20 may accurately authenticate the consumable, ensuring that the authenticated consumable is the designated consumable that meets the quality requirements, and preventing the image forming apparatus 20 from being damaged and the image forming quality from being affected due to the use of any other consumable that does not meet the quality requirements.

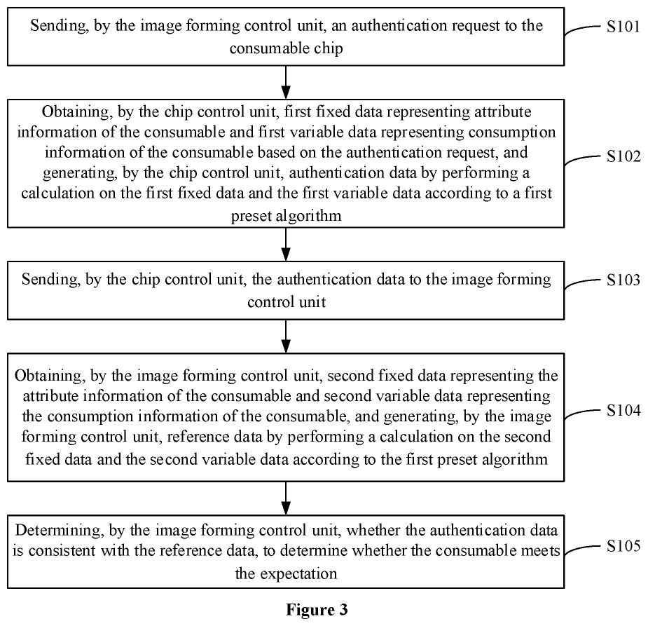

FIG. 3 illustrates a schematic flowchart of a communication method between an image forming apparatus and a consumable chip consistent with an embodiment of the present disclosure. The method may be applied to the image forming apparatus and the consumable chip. Referring to FIG. 3, the image forming apparatus may be detachably installed with a consumable, and the consumable may be installed with the consumable chip. The image forming apparatus may include an image forming control unit, and the consumable chip may include a chip control unit. The method may include following.

S101: sending, by the image forming control unit, an authentication request to the consumable chip.

S102: based on the authentication request, obtaining, by the chip control unit, first fixed data representing attribute information of the consumable and first variable data representing consumption information of the consumable, and generating, by the chip control unit, authentication data by performing a calculation on the first fixed data and the first variable data according to a first preset algorithm.

S103: sending, by the chip control unit, the authentication data to the image forming control unit.

S104: obtaining, by the image forming control unit, second fixed data representing attribute information of the consumable and second variable data representing consumption information of the consumable, and generating, by the image forming control unit, reference data by performing a calculation on the second fixed data and the second variable data according to the first preset algorithm.

S105: determining, by the image forming control unit, whether the authentication data is consistent with the reference data, to determine whether the consumable meets the expectation.

After determining that the consumable meets the expectation in S105, the first variable data may include information of a quantity of printed pages, remaining amount of the consumable and consumption amount of the consumable, and the first fixed data may include the serial number of the consumable, the model of the consumable, and the capacity of the consumable. The second variable data may include information of a quantity of printed pages, remaining amount of the consumable and consumption amount of the consumable, and the second fixed data may include the serial number of the consumable, the model of the consumable, and the capacity of the consumable.

In the disclosed communication method between the image forming apparatus and the consumable chip, the chip control unit of the consumable chip may generate the authentication data using the stored first fixed data representing attribute information of the consumable and first variable data representing the consumption information of the consumable. The image forming apparatus may authenticate the consumable chip using the authentication data. Because the authentication data is dynamically variable, the authentication data received by the image forming apparatus may be highly reliable, and the image forming apparatus may accurately authenticate the consumable, ensuring that the authenticated consumable is the designated consumable that meets the quality requirements, and preventing the image forming apparatus from being damaged and the image forming quality from being affected due to the use of any other consumable that does not meet the quality requirements.

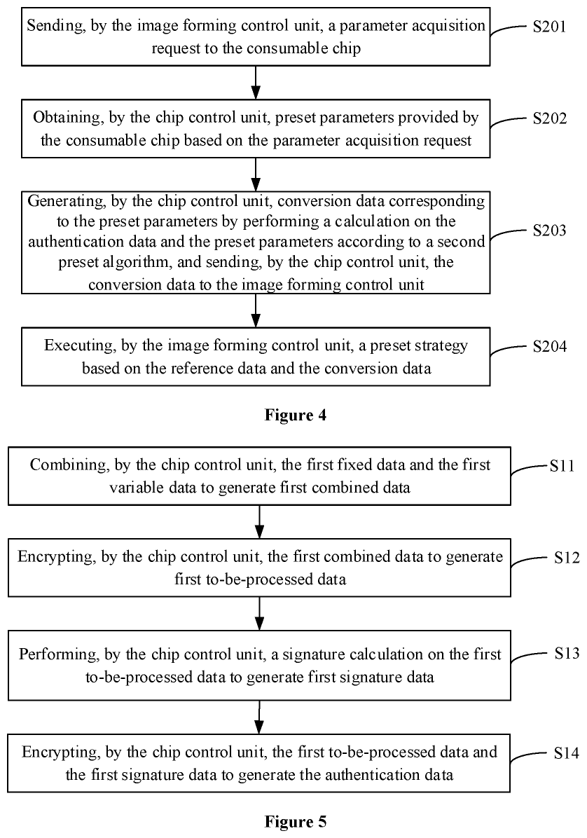

Referring to FIG. 4, in one embodiment, the above-disclosed method may further include following.

S201: sending, by the image forming control unit, a parameter acquisition request to the consumable chip.

S202: obtaining, by the chip control unit, preset parameters provided by the consumable chip based on the parameter acquisition request.

S203: generating, by the chip control unit, conversion data corresponding to the preset parameters by performing a calculation on the authentication data and the preset parameters based on a second preset algorithm, and sending, by the chip control unit, the conversion data to the image forming control unit.

S204: executing, by the image forming control unit, a preset strategy based on the reference data and the conversion data.

When the preset parameters include image forming control parameters, the preset strategy may include determining whether the consumable meets expectation according to the image forming control parameters, and adjusting the characteristics of the image forming control parameters to improve the image forming effect.

When the preset parameters include consumable parameters, the preset strategy may include obtaining information of the consumable according to the consumable parameters.

The chip control unit may generate the conversion data by performing an encryption calculation on the preset parameters using the authentication data. Then, the chip control unit may send the conversion data to the image forming control unit. The image forming control unit may decrypt the conversion data using the reference data, and may execute the preset strategy according to the decrypted data. Because the authentication data and the reference data are dynamically variable, the authentication data may be used to encrypt the preset parameters, which may improve the difficulty of data analysis. Further, the authentication data may be updated in real time, which may make it substantially difficult to crack the conversion data, thereby enhancing the security and reliability of the data sent by the chip control unit to the image forming control unit, and may prevent the data sent by the chip control unit to the image forming control unit from being maliciously intercepted and embezzled.

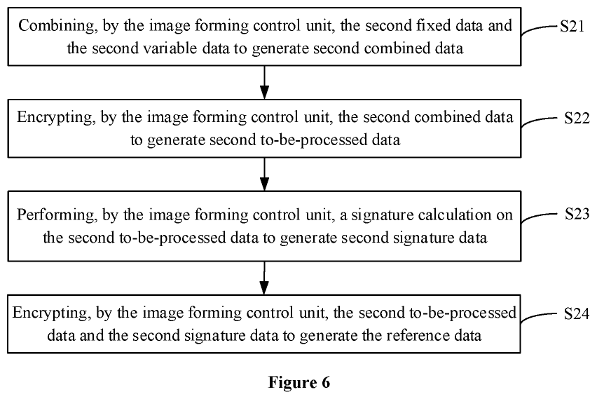

Referring to FIG. 5, S102 may specifically include following.

S11: combining, by the chip control unit, the first fixed data and the first variable data to generate first combined data.

S12: encrypting, by the chip control unit, the first combined data to generate first to-be-processed data.

S13: performing, by the chip control unit, a signature calculation on the first to-be-processed data to generate first signature data.

S14: encrypting, by the chip control unit, the first to-be-processed data and the first signature data to generate the authentication data.

The first fixed data may undergo multiple encryption and signature calculations, and the result obtained each time may be the same, in other words, a fixed result may be obtained. When performing multiple encryption and signature calculations on the combined data of the first variable data and the first fixed data, because the first variable data is different each time, the results obtained by performing multiple encryption and signature calculations on the combined data of the first variable data and the first fixed data may be different, in other words, variable results may be obtained. The analysis of the variable results may be more difficult than the analysis of the fixed result, thereby improving the security and reliability of the authentication data. In addition, because the first fixed data and the first variable data are combined to obtain the first combined data, a data length of the first combined data may be greater than a data length of the first fixed data. The encryption difficulty of the first combined data may increase, and the decryption difficulty of the first combined data may increase, thereby further improving the security and reliability of the authentication data.

Referring to FIG. 6, S104 may specifically include following.

S21: combining, by the image forming control unit, the second fixed data and the second variable data to generate second combined data.

S22: encrypting, by the image forming control unit, the second combined data to generate second to-be-processed data.

S23: performing, by the image forming control unit, a signature calculation on the second to-be-processed data to generate second signature data.

S24: encrypting, by the image forming control unit, the second to-be-processed data and the second signature data to generate the reference data.

The second fixed data may undergo multiple encryption and signature calculations, and the result obtained each time may be the same, in other words, a fixed result may be obtained. When performing multiple encryption and signature calculations on the combined data of the second variable data and the second fixed data, because the second variable data is different each time, the results obtained by performing multiple encryption and signature calculations on the combined data of the second variable data and the second fixed data may be different, in other words, variable results may be obtained. The analysis of the variable results may be more difficult than the analysis of the fixed result, thereby improving the security and reliability of the reference data. In addition, because the second fixed data and the second variable data are combined to obtain the second combined data, a data length of the second combined data may be greater than a data length of the second fixed data. The encryption difficulty of the second combined data may increase, and the decryption difficulty of the second combined data may increase, thereby further improving the security and reliability of the reference data.

The disclosed embodiments may have following beneficial effects. The chip control unit of the consumable chip may generate the authentication data using the stored first fixed data representing attribute information of the consumable and first variable data representing the consumption information of the consumable. The image forming apparatus may authenticate the consumable chip using the authentication data. Because the authentication data is dynamically variable, the authentication data received by the image forming apparatus may be highly reliable, and the image forming apparatus may accurately authenticate the consumable, ensuring that the authenticated consumable is the designated consumable that meets the quality requirements, and preventing the image forming apparatus from being damaged and the image forming quality from being affected due to the use of any other consumable that does not meet the quality requirements.

It should be noted that the disclosed embodiments are merely examples for illustrating the technical solutions of the present disclosure, but are not limited thereto. Although the present disclosure has been described in detail with reference to the foregoing embodiments, those skilled in the art should understand that the technical solutions described in the foregoing embodiments can still be modified, or equivalently replace some or all of the technical features. Such modification or replacement thereof does not depart from the spirit and principle of the present disclosure, and falls within the true scope of the present disclosure.

What is claimed is:

1. A consumable chip, wherein the consumable chip is capable of being installed on a consumable, the consumable is capable of being detachably installed on an image forming apparatus, and the consumable chip comprising:
a first storage unit, configured to store first fixed data representing attribute information of the consumable; and
a chip control unit, configured to:
receive an authentication request sent by the image forming apparatus,
obtain the first fixed data and first variable data representing consumption information of the consumable based on the authentication request,
generate authentication data by performing a calculation on the first fixed data and the first variable data according to a first preset algorithm, and
send the authentication data to the image forming apparatus, wherein the authentication data is used to determine whether the consumable meets expectation.

2. The consumable chip according to claim 1, wherein the chip control unit is further configured to:
receive a parameter acquisition request sent by the image forming apparatus,
obtain preset parameters provided by the consumable chip based on the parameter acquisition request,
generate conversion data corresponding to the preset parameters by performing a calculation on the authentication data and the preset parameters according to a second preset algorithm, and
send the conversion data to the image forming apparatus, wherein the conversion data is configured to execute a preset strategy.

3. The consumable chip according to claim 2, wherein:
the preset parameters include image forming control parameters, and
the preset strategy includes determining whether the consumable meets the expectation according to the image forming control parameters.

4. The consumable chip according to claim 1, wherein:
the first variable data includes information of a quantity of printed pages, remaining amount of the consumable, and consumption amount of the consumable, and
the first fixed data includes a serial number of the consumable, a model of the consumable, capacity of the consumable.

5. A consumable, comprising:
a case;
a developer accommodating unit, disposed in the case and configured to accommodate developer; and
a consumable chip, wherein the consumable chip is capable of being installed on a consumable, the consumable is capable of being detachably installed on an image forming apparatus, and the consumable chip comprising,
a first storage unit, configured to store first fixed data representing attribute information of the consumable, and
a chip control unit, configured to:
receive an authentication request sent by the image forming apparatus,
obtain the first fixed data and first variable data representing consumption information of the consumable based on the authentication request,
generate authentication data by performing a calculation on the first fixed data and the first variable data according to a first preset algorithm, and
send the authentication data to the image forming apparatus, wherein the authentication data is used to determine whether the consumable meets expectation.

6. The consumable chip according to claim 5, wherein the chip control unit is further configured to:
receive a parameter acquisition request sent by the image forming apparatus,
obtain preset parameters provided by the consumable chip based on the parameter acquisition request,
generate conversion data corresponding to the preset parameters by performing a calculation on the authentication data and the preset parameters according to a second preset algorithm, and
send the conversion data to the image forming apparatus, wherein the conversion data is configured to execute a preset strategy.

7. The consumable chip according to claim 6, wherein:
the preset parameters include image forming control parameters, and
the preset strategy includes determining whether the consumable meets the expectation according to the image forming control parameters.

8. The consumable chip according to claim 5, wherein:
the first variable data includes information of a quantity of printed pages, remaining amount of the consumable, and consumption amount of the consumable, and
the first fixed data includes a serial number of the consumable, a model of the consumable, capacity of the consumable.

9. The consumable according to claim 5, further including:
a developer conveying unit, configured to convey the developer.

10. The consumable according to claim 9, further including:
an organic photoconductor, and
a charging roller, configured to charge the organic photoconductor.

11. A consumable, comprising:
an organic photoconductor,
a charging roller, configured to charge the organic photoconductor, and
a consumable chip, wherein the consumable chip is capable of being installed on a consumable, the consumable is capable of being detachably installed on an image forming apparatus, and the consumable chip comprising:
a first storage unit, configured to store first fixed data representing attribute information of the consumable; and
a chip control unit, configured to:
receive an authentication request sent by the image forming apparatus,
obtain the first fixed data and first variable data representing consumption information of the consumable based on the authentication request,
generate authentication data by performing a calculation on the first fixed data and the first variable data according to a first preset algorithm, and
send the authentication data to the image forming apparatus, wherein the authentication data is used to determine whether the consumable meets expectation.

12. The consumable chip according to claim 11, wherein the chip control unit is further configured to:
receive a parameter acquisition request sent by the image forming apparatus,
obtain preset parameters provided by the consumable chip based on the parameter acquisition request,
generate conversion data corresponding to the preset parameters by performing a calculation on the authentication data and the preset parameters according to a second preset algorithm, and
send the conversion data to the image forming apparatus, wherein the conversion data is configured to execute a preset strategy.

13. The consumable chip according to claim 12, wherein:
the preset parameters include image forming control parameters, and
the preset strategy includes determining whether the consumable meets the expectation according to the image forming control parameters.

14. The consumable chip according to claim 11, wherein:
the first variable data includes information of a quantity of printed pages, remaining amount of the consumable, and consumption amount of the consumable, and
the first fixed data includes a serial number of the consumable, a model of the consumable, capacity of the consumable.

15. A communication method between an image forming apparatus and a consumable chip, applied to the image forming apparatus and the consumable chip, the image forming apparatus being detachably installed with a consumable, the consumable being installed with the consumable chip, the image forming apparatus including an image forming control unit, the consumable chip including a chip control unit, and the communication method comprising:
sending, by the image forming control unit, an authentication request to the consumable chip;
obtaining, by the chip control unit, first fixed data representing attribute information of the consumable and first variable data representing consumption information of the consumable based on the authentication request, and generating, by the chip control unit, authentication data by performing a calculation on the first fixed data and the first variable data according to a first preset algorithm;
sending, by the chip control unit, the authentication data to the image forming control unit;
obtaining, by the image forming control unit, second fixed data representing the attribute information of the consumable and second variable data representing the consumption information of the consumable, and generating, by the image forming control unit, reference data by performing a calculation on the second fixed data and the second variable data according to the first preset algorithm; and
determining, by the image forming control unit, whether the authentication data is consistent with the reference data, to determine whether the consumable meets expectation.

16. The method according to claim 15, further including:
sending, by the image forming control unit, a parameter acquisition request to the consumable chip,
obtaining, by the chip control unit, preset parameters provided by the consumable chip based on the parameter acquisition request,
generating, by the chip control unit, conversion data corresponding to the preset parameters by performing a calculation on the authentication data and the preset parameters according to a second preset algorithm, and sending, by the chip control unit, the conversion data to the image forming control unit, and
executing, by the image forming control unit, a preset strategy based on the reference data and the conversion data.

17. The method according to claim 16, wherein:
the preset parameters include image forming control parameters, and
the preset strategy includes determining whether the consumable meets the expectation according to the image forming control parameters.
